(19) United States
(12) Patent Application Publication
(10) Pub. No.: US 2007/0009139 A1
(43) Pub. Date: Jan. 11, 2007

(54) Facial recognition device for a handheld electronic device and a method of using the same

(75) Inventors: Assaf Landschaft, Munich (DE); Shajith Chacko Thengummootil, Bangalore (IN)

Correspondence Address: HITT GAINES, PC;AGERE SYSTEMS INC., PO BOX 832570, RICHARDSON, TX, 75083, US

(73) Assignee: Agere Systems Inc., Allentown, PA (US)

(21) Appl. No.: 11/178,944

(22) Filed: Jul. 11, 2005

(51) Int. Cl. G06K 9/00

(52) U.S. Cl. 382/115; 340/5.53

(57) ABSTRACT

Introduced is a method for enhancing the security of a handheld electronic device, in particular a mobile communication device. In one embodiment, the method includes (1) providing biometric reference data of an authorized user of functions of a handheld electronic device; (2) capturing the biometric user data of a party requesting access to functions of the handheld electronic device; and (3) comparing the biometric user data with the biometric reference data and determining whether the party is an authorized user.

### TECHNICAL FIELD OF THE INVENTION

The present invention is directed, in general, to a security device for a handheld electronic device and, more specifically, to a facial recognition device that provides conditional user access to a handheld electronic device.

### BACKGROUND OF THE INVENTION

Handheld electronic devices such as mobile phones or PDAs are constant companions for a large portion of the population in industrial countries. Ongoing technological developments have made handheld mobile communications devices with a very high memory capacity available at affordable prices. Many mobile communications devices now have additional features, such as digital cameras, incorporated into them. These digital cameras are of a relatively high quality with good resolution.

The increased memory capacity of handheld devices, such as mobile phones, makes it very convenient for a user to use the device for the storage of confidential or other valuable information. Of course the user does not want such information disclosed or revealed to unauthorized third parties. For example, business and personal schedules, meeting plans and e-mails of are generally thought of as confidential information that is not to be revealed to unauthorized persons. In addition to the protection of confidential information, the owner of a mobile communication device does not want an unauthorized third party using his or her device because the cost of such use will be billed to the owner.

Most handheld device users carry it with them at all times, which increases the risk of loss or theft. For this reason it is desirable to have security measures built into the device to protect the unauthorized disclosure of information stored therein as well as to prevent usage of the device by an unauthorized third party.

The standard, and frequently only, security feature of most mobile phones is a PIN code (Personal Identification Number) system that, if enabled, requires a user to enter his or her PIN each time the device is activated. Most PIN codes consist of a four-digit number selected by the user, which means security of the device is actually very limited. Because the number is short, the particular PIN code can be easily stolen or even guessed by an unauthorized user since most users tend to choose a simple PIN code that can be easily memorized or that can be input with minimal effort. Furthermore, if a mobile phone should be stolen because it has sensitive business data stored therein, such as telephone numbers of clients or business associates, relatively unsophisticated programs can be used to figure out the PIN code and access the information. In any such case the handheld device and all information on it will be compromised.

In the case of other security sensitive applications, such as access to buildings, restricted areas, laboratories or manufacturing sites, more elaborate security systems are used. These usually involve identity cards at a minimum, but other security identification systems are also in use, such as facial recognition screening. For example, in U.S. Patent Application No. 20030142853, entitled SECURITY IDENTIFICATION SYSTEM, by Waehner, Glenn, et al., a security identification system utilizing facial recognition for screening individuals passing through a secure entry or checkpoint is described. The system, which is connected to a computer system, captures and analyzes a person's facial features by comparing them with data stored in the systems computer database.

In U.S. Pat. No. 5,787,186, entitled BIOMETRIC SECURITY PROCESS FOR AUTHENTICATING IDENTITY AND CREDIT CARDS, VISAS, PASSPORTS AND FACIAL RECOGNITION, to Schroeder, Carlos C., a biometric security procedure is described for use with an identity document such as ID or credit card. The method in Schroeder is based on analyzing certain basic facial features of the image of the person as used on an identity document, transforming such features into a numeric code by means of comparing the features with a master pattern of features in a database, which numeric code is also printed on the identity document. This system provides a means of protection against any tampering with or forging of identity documents. However, the method described in Schroeder does not provide for the automatic authentication of the identity of the person using the identity document.

Accordingly, what is needed in the art is a new and improved approach for preventing unauthorized access to handheld electronic devices, in particular mobile communications devices.

### SUMMARY OF THE INVENTION

To address the above-discussed deficiencies of the prior art, the present invention provides a method for restricting access to the functions of a handheld electronic device. In one embodiment, the method includes (1) providing biometric reference data of an authorized user of functions of the handheld electronic device; (2) capturing the biometric user data of a party requesting access to the functions of the handheld electronic device; and (3) comparing the biometric user data with the biometric reference data and determining whether the party is an authorized user.

Thus the present invention provides a method to restrict access to the functions of a handheld electronic device by comparing certain biometric functions of an authorized user with the biometric functions of a party attempting to access functions of the electronic device. This invention is particularly useful for restricting access to such devices as mobile phones, laptop and notebook computers, personal digital assistants (PDAs), as well as any other handheld electronic device to which access is limited to specific parties.

In one embodiment the biometric reference data includes at least one first characteristic data set that unequivocally identifies the authorized user and the biometric user data includes a second characteristic data set that unequivocally identifies the party requesting access. The first and second characteristic sets are compared and access to the functions of the handheld electronic device is permitted if the two characteristic sets match.

In another embodiment the biometric reference data is stored in the memory of the handheld electronic device. A useful embodiment of the method provides for the biometric user data to be a facial image of the party requesting access. This is particularly useful in the case of an embodiment where a camera is integrated into the handheld electronic device that can be used to capture the biometric user data.

In still another embodiment, biometric user data and biometric reference data calls for processing a facial image by determining a position or arrangement, or both together, of salient points of the facial image. Where a camera is integrated into a handheld electronic device, another embodiment provides for the device to instruct a party requesting access to repeat the capture of the biometric user data by using a different view of the facial image. This permits a greater degree of certainty in permitting access to electronic device functions by permitting redundant checks. It also allows a recheck of the biometric user features where the initial facial image does not provide a complete match, such as where something may have happened to change certain features such as a weight gain or loss or where significant aging has occurred and the biometric reference data has not been updated.

One embodiment of the device provides for the biometric reference data to be selected from a group consisting of fingerprint data; retina data; iris data; body geometry data; voice data; and DNA data. In yet another embodiment of the invention, a plurality of items of biometric reference data is provided and the biometric user data is compared with more than one of this plurality. Access to the handheld electronic device can be given if the biometric user data items match only one of the biometric reference data items or access can be made more restrictive by requiring more than one match to be made.

In still yet another embodiment of the invention, redundancy is provided by requiring a matching of a personal identification number (PIN) entered by the party requesting access with a reference PIN. Thus, the present invention permits a number of ways to provide redundant controls that restrict access to a handheld electronic device to only authorized parties.

Although the methods provided can be used to restrict access to any type of handheld electronic device, it is particularly useful when the handheld electronic device is a mobile communications device. It is particularly useful in restricting access to mobile phones.

The present invention also provides a device for controlling access to handheld electronic device functions that permit the implementation of the foregoing methods. In one embodiment, the device provides (1) a means for storing biometric reference data of an authorized user of the handheld electronic device functions; (2) a means for capturing biometric user data of a party requesting access to the handheld electronic device functions; and (3) a means for comparing the biometric user data with the biometric reference data. In other embodiments, the device implement the methods described above, which embodiments will be readily apparent to those of ordinary skill in the pertinent art.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a front plan view of a handheld electronics device, a mobile phone, incorporating an embodiment of the present invention;

FIG. 2 illustrates a schematic of a party requesting access to the functions of a handheld electronic device that has the present invention incorporated therein;

FIG. 3 illustrates a front plan view of a mobile phone showing a facial image captured in accordance with one embodiment of the present invention;

FIG. 4 illustrates a front plan view of certain exemplary salient points of a facial image that comprise biometric user data to be compared with biometric reference data in accordance with the present invention;

FIG. 5 illustrates a flow chart of an embodiment of the invention that provides a method for the optional application of redundant access limitations, consisting of (i) capturing a facial image for a comparison of biometric user data with biometric reference data, and (ii) a requirement that a PIN be provided; and

FIG. 6 illustrates a front plan view of a handheld electronic device that provides for the capture of a fingerprint as biometric user data.

### DETAILED DESCRIPTION

Before describing the FIGUREs, various aspects, embodiments and features of the present invention will be described. The invention presents a method for restricting access to the functions of a handheld electronic device, in particular a mobile communication device such as a mobile phone. The invention provides for the provision of biometric reference data of an authorized user or authorized users, as the case may be, of a handheld electronic device. When a party requests access to the functions of such a handheld electronic device, certain biometric user data of the party requesting access is captured and compared with the biometric reference data. Access to the device can then be controlled based on such comparison. For example, in the case of a laptop computer where children have also have access, unlimited access can be provided to adults and restricted access can be provided to children.

To utilize the present invention it is desirable to utilize as the biometric reference data of a user, characteristic features that identify the person that also serve to distinguish such person from others. It is also desirable to use biometric data that will consistently identify that person when the person's biometric data is captured at different times.

In one embodiment of the invention, features that unequivocally provide biometric reference data are used. Such data may consist of, for example, fingerprints and DNA. Such biometric data advantageously provides a first characteristic data set that unequivocally identifies an authorized user and is used as biometric reference data for restricting access to a handheld electronic device where such access must be rigorously controlled, such as in the case of certain security applications. Thus, access is restricted to the party requesting access where the capturing biometric data of the party requesting access produces a second characteristic data set that unequivocally identifies such party. This embodiment is most advantageously used when associated with an embodiment of the invention where the biometric reference data is stored in the memory of the handheld electronic device so that the handheld electronic device is independent of an external apparatus, such as a separate computer or server that serves as an external database to store biometric reference data.

It is envisioned, in one embodiment of the invention, that a user of a handheld electronic device will be required to provide facial biometric user data each time the device is turned on. An advantageous embodiment of the present invention provides for a built-in camera to capture an image of the user's face to provide the biometric user data. The salient points of the user's face comprise the biometric user data that will be compared with the salient points of the user's face stored in the device as biometric reference data. The captured facial image can also be stored on the device for performing the comparison at a later time if only certain functions on the device require such restrictions, or alternatively it can be compared immediately upon capture to obviate the need for such storage. Because many mobile communication devices phones are already equipped with digital cameras that provide high quality facial images, access control based on biometric data utilizing facial recognition can be easily implemented. However, as will be readily understood by a person of ordinary skill in the pertinent art, any type of biometric data lies within the intended scope of the present invention.

To generate a characteristic data set based on facial characteristics that unequivocally identifies a party requesting access, in one embodiment of the invention the biometric data consists of a facial image data determining by the position or arrangement, or both, of salient points of the facial image such as the position of the eyes, ears, mouth, etc. or points on the boundary line of the face. Of course, when capturing biometric user data of a party attempting to access the device, the position and orientation of the party's face relative to the camera is important. It is possible that a comparison of the biometric user data derived from the captured facial image in certain circumstances will not match the biometric reference data, although the party requesting access is an authorized user and the stored biometric reference data is perfectly valid. In such case, an embodiment of the present invention provides for the handheld electronic device to generate a request for the party seeking access to repeat the step of capturing his or her facial image after adjusting the position and orientation of the party's face relative to the camera. Of course, the sensitivity of the comparison parameters can be set so high that only a perfect match will authorize access to certain features of the handheld electronic device. In such a case a request may be made to recapture the facial image even though a comparison of parameters indicates the party attempting to use the device is, more probably than not, authorized access.

Although facial image biometric data is probably the easiest embodiment of the present invention to implement because several known methods of facial recognition exist, any other recognized biometric data can be also be utilized and be within the intended scope of the present invention. Such other biometric data can include, for example, fingerprint data, retina data, iris data, body geometry data, voice data or even DNA data as well as other biometric data currently being developed.

Other recognition techniques can also be used in conjunction with biometric data to increase the probability that only a party definitely authorized access to certain functions of a handheld electronic device will be provided such access. For example, the utilization of a PIN in association with biometric data can be used to increase the certainty of access control. Thus, in one embodiment of the invention, a party seeking access to functions of the handheld electronic device will be required to enter a PIN, which will be used together with captured biometric user data to control access.

In the case of more than one party being authorized access to a handheld electronic device, biometric reference data will be provided for each party. This will generally entail captured biometric user data being compared with each biometric reference data set in order to determine if the party is authorized access. Access will be granted if the captured biometric user data matches at least one of the stored sets of biometric reference data. As will be readily understood by those of ordinary skill in the pertinent art, the use of a PIN can be used to decrease processing time in such a case by identifying the biometric reference set by reference to the PIN number of the party seeking access, which identified biometric reference set will be compared with the captured biometric user data.

In addition to storing biometric reference data for more than one person, more than one set of biometric reference data for a single party can also be stored. If more than one set of facial image biometric reference data for a single party is stored, the probability of matching captured biometric user data is increased. In some cases the level of security for access to the features of the handheld electronic device may provide that access is granted if the captured biometric user data matches only one of the sets of biometric reference data. In other cases, where the desired security level of access is high, it may be required that more than one of the sets of biometric reference data be matched before access is granted. In certain cases the level of security may be so high that all the sets of biometric data must be matched before access is granted. The sensitivity of the facial recognition can thus be scaled according to the circumstances. Of course facial features used as biometric reference data can be combined with other types of biometric data. For example, in one embodiment illustrated and described herein, facial features as one set of biometric reference data is combined with a fingerprint as another set of biometric reference data.

The present invention also provides for a device for controlling access to handheld electronic device functions. Such a device provides for a means for storing biometric reference data of an authorized user of a handheld electronic device's functions; a means for capturing biometric user data of a party requesting access to the handheld electronic device functions; and a means for comparing the biometric user data with the biometric reference data. Other embodiments of the device call for features implementing the methods described above. Although a handheld electronic device with a built-in camera is described above, those of ordinary skill in the pertinent art will understand that other means for capturing biometric user data can also be built into such a device. For example, a pad to capture fingerprint biometric data can be built into a handheld electronic device, as can a microphone for capturing voice based biometric data. If a handheld electronic device is equipped with two different security functions, these can be separately activated depending on a predetermined setting. Such security functions can include other security functions currently in use, such as requiring a PIN before access is granted.

Because the controlling means for the present invention is preferably a microprocessor adapted to execute a software program stored in the device, a digital storage medium containing electronically readable control instructions to enable a handheld electronic device to control access to handheld electronic device functions by comparing stored biometric reference data of an authorized user with captured biometric user data of a party requesting access is within the intended scope of the present invention. A means for activating said digital storage medium with electronically readable control instructions adapted to execute the methods described herein (such as a microchip to be inserted in a handheld electronic device) is also within the intended scope of the present invention.

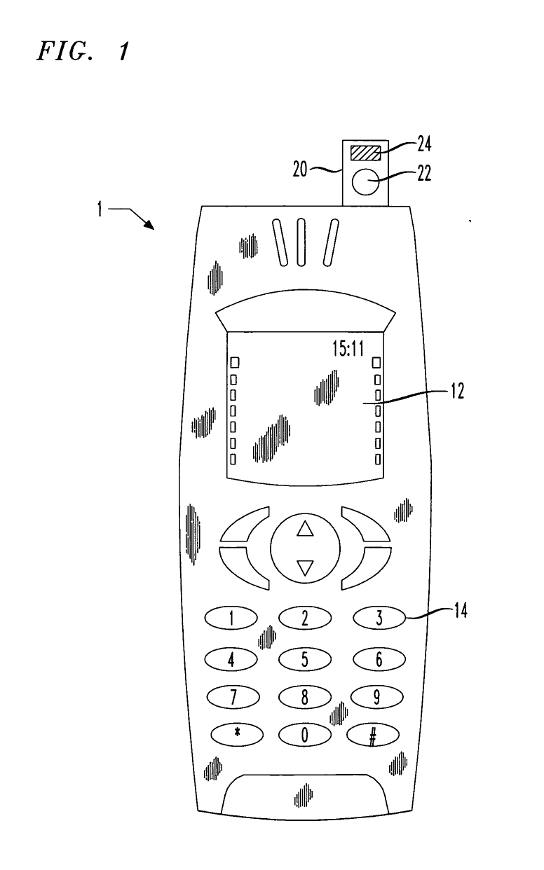

Turning now to FIG. 1, illustrated is a frontal plan view of a handheld electronics device, a mobile phone 1, incorporating an embodiment of the present invention. The mobile phone 1 has a built-in camera 20 for capturing a facial image of a party seeking access to certain features of the mobile phone 1. The features of this facial image are used as biometric user data to be compared with a stored biometric reference data of an authorized user to unequivocally identify whether or not the party seeking access to the features of the mobile phone is an authorized user. The present invention is enabled by a stored software application in the mobile phone 1 that requires stored biometric reference data based on the facial features of an authorized user to match captured biometric user data of the party attempting to use the mobile phone 1. The mobile phone 1 has a camera 20 with a lens 22 that has a focal length suitable for capturing a facial image. The camera 20 also has a flash 24 for use in low light conditions. Also shown is a display screen 12 and a keypad 14 by means of which a user can input and receive data.

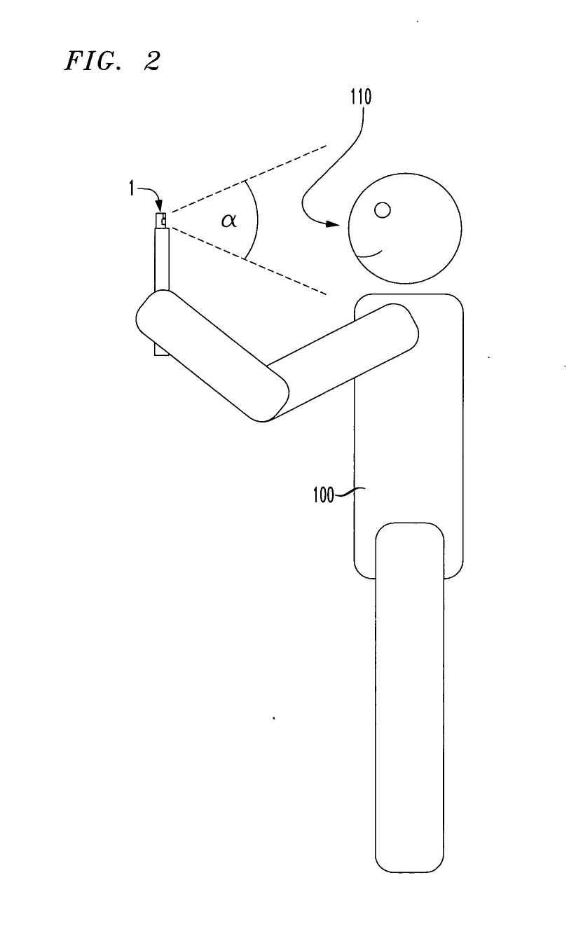

Turning now to FIG. 2, illustrated is a schematic of a party requesting access to the functions of a handheld electronic device with the present invention incorporated therein. Shown is the orientation and position of the mobile phone 1 shown in FIG. 1 relative to the face 110 of a party 100 requesting access. As illustrated, the face 110 of the party 100 requesting access lies within the angle of view a of the camera 20 on the mobile phone 1. The party 100 is providing a frontal view to the camera 20 and is oriented such that the party's face 110 is centered and vertically aligned within the captured image.

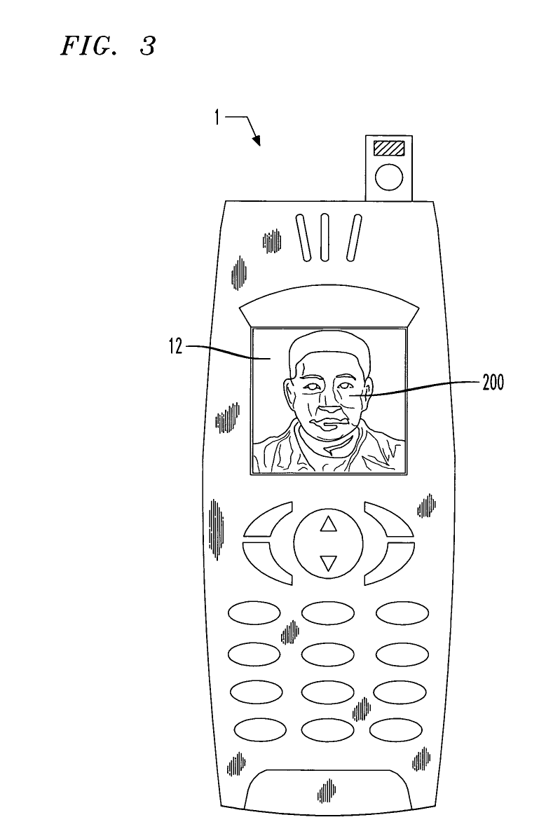

Turning now to FIG. 3, illustrated is a front plan view of a mobile phone 1 showing a facial image of a user 100 captured in accordance with one embodiment of the present invention. For the user's 100 convenience, the mobile phone 1 advantageously provides a preview 200 function of the captured image of the party's face 110 on the display screen 12. The mobile phone 1 can be provided with a function that allows the user to trigger use of the captured facial image by pressing a key on the keypad 14 if he or she is satisfied with the preview 200 position and orientation of his or her face 110.

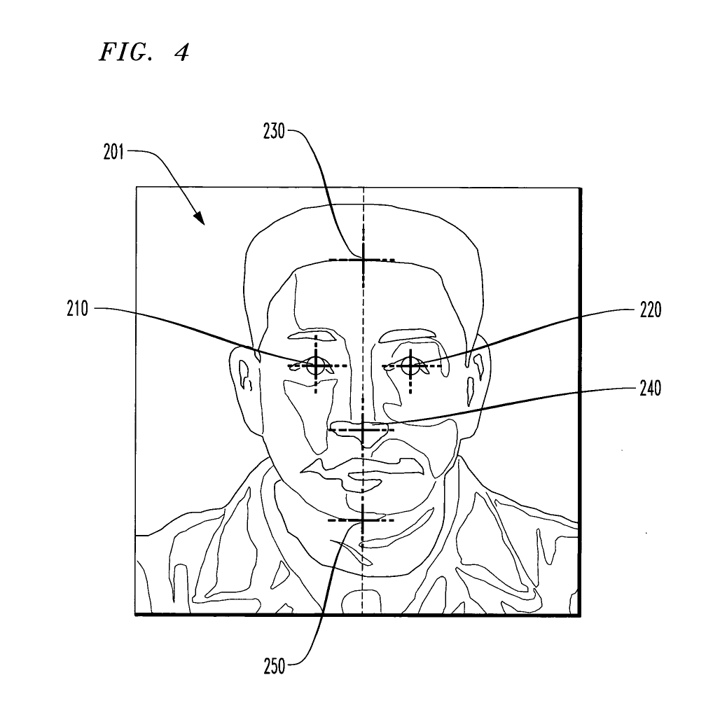

FIG. 4 illustrates a front plan view of certain exemplary salient points of a facial image 210 that comprise the biometric user data to be compared with biometric reference data in accordance with the present invention. Biometric user data and biometric reference data for a facial image 210 is determined by the salient points of the face representing the uniqueness of a particular facial image 210. For example, illustrated salient points 210 and 220 define the eyes, point 240 defines the tip of the nose and points 230 and 250 respectively define the hairline and chin tip of the captured facial image 201. Accordingly, this simple example permits a person to be identified by the relative positions of these salient points. In order to achieve a high degree of reliability more elaborate facial recognition techniques can also be employed. As will be understood by those of ordinary skill in the pertinent art, in utilizing the present invention to enhance the security of a handheld electronic device, any facial recognition technique can be utilized, whether now known or subsequently developed.

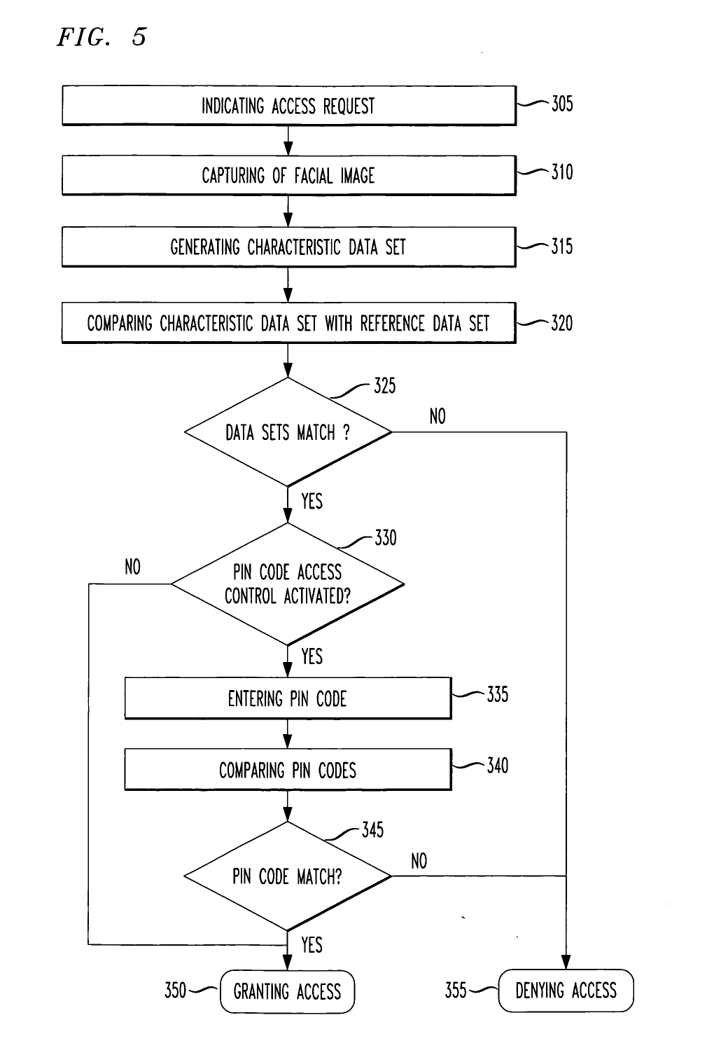

FIG. 5 illustrates a flow chart of an embodiment of the invention that optionally provides a method for utilizing redundant access limitations of (i) capturing a facial image for a comparison of biometric user data with biometric reference data, and (ii) a requirement that a PIN be provided. Initially, the party seeking access user indicates 305 a request to access the handheld electronic device by, for example, pressing a key or key combination on a keypad on the device. In the illustrated embodiment the enhanced security of requiring facial recognition is employed, so a facial image of the party requesting access is captured 310. To capture the facial image of the party requesting access, a digital camera associated with the device can be employed that yields a digital representation of the facial image. This digital representation is processed to evaluate the salient points of the face, thereby generating 315 a characteristic data set or biometric user data based on facial recognition. In this fashion the party requesting access can be unequivocally identified. The biometric user data is compared 320 with the biometric user data stored in the device. If the biometric user data and the biometric reference data do not match 325, the party is denied access 355 to the functions of the device.

As previously described, several different sets of biometric reference data for the same authorized user can be stored in the device. This permits the captured biometric user data to be compared with each set of biometric reference data for a particular user. In certain embodiments of the present invention, if the captured biometric user data matches 325 the biometric reference data, or in the case of a plurality of sets of biometric reference data, if it matches a predefined number of sets of biometric reference data, access can be granted. However, when PIN code access control 330 is activated, access is granted only if the biometric data matches and the party seeking access also enters a correct PIN. If PIN code access control 330 is not activated, access is granted to the party based on the match of the biometric user data with the biometric reference data. When PIN code access control 330 is activated, the party seeking access enters his or her PIN code 335, which is compared 340 to a stored reference PIN code and, if the PIN codes match 345, access is granted 350, otherwise it is denied 355.

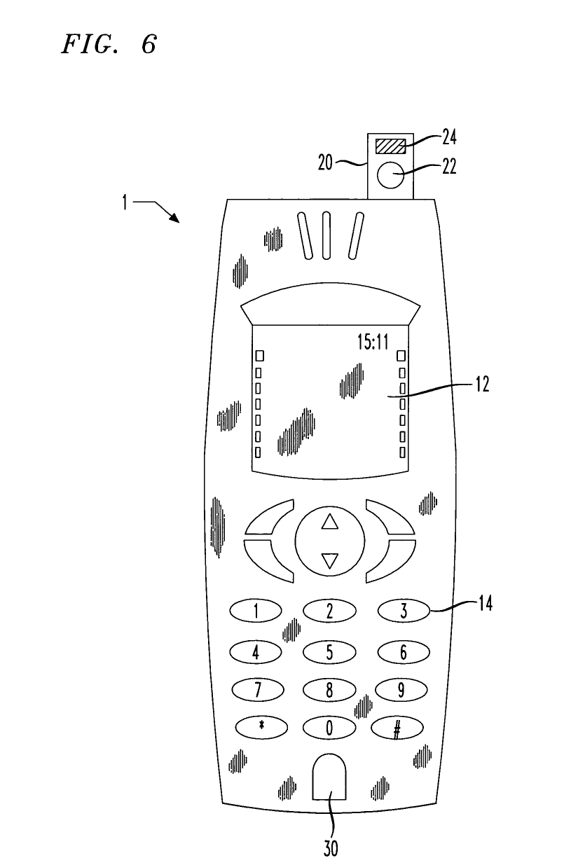

FIG. 6 illustrates a front plan view of a handheld electronic device 1 that provides for the capture of a fingerprint as biometric user data. In this embodiment, redundant security functions are provided by requiring facial recognition using a camera 20 and fingerprint recognition using a fingerprint pad 30. In addition a PIN code access control can also be required. In some embodiments, each of these separate security functions can be activated separately in accordance with user preferences.

Although the present invention has been described in detail, those skilled in the art should understand that they can make various changes, substitutions and alterations herein without departing from the spirit and scope of the invention in its broadest form.

What is claimed is:

1. A method of restricting access to functions of a handheld electronic device, comprising:
providing biometric reference data of an authorized user of said functions;
capturing biometric user data of a party requesting access to said functions; and
comparing said biometric user data with said biometric reference data and determining whether said party is an authorized user.

2. The method as recited in claim 1 wherein said biometric reference data includes at least one first characteristic data set that unequivocally identifies said authorized user and said biometric user data includes a second characteristic data set that unequivocally identifies said party requesting access, and said comparing includes a comparison of said first characteristic data set and said second characteristic data set.

3. The method as recited in claim 1 further comprising storing said biometric reference data in a memory of said handheld electronic device.

4. The method as recited in claim 1 further comprising using a camera integrated in said handheld electronic device for said capturing.

5. The method as recited in claim 4 wherein said biometric user data is a facial image of said party requesting access.

6. The method as recited in claim 5 further comprising processing said facial image by determining a position or arrangement, or both together, of salient points of said facial image.

7. The method as recited in claim 5 further comprising instructing said party requesting access to repeat said capturing using a different view of said facial image.

8. The method as recited in claim 1 wherein said biometric reference data is selected from a group consisting of:
fingerprint data;
retina data;
iris data;
body geometry data;
voice data; and
DNA data.

9. The method as recited in claim 1 further comprising matching a PIN entered by said party requesting access with a reference PIN.

10. The method as recited in claim 1 further comprising providing a plurality of said biometric reference data and comparing said biometric user data with more than one of said plurality.

11. The method as recited in claim 10 wherein said access is permitted when said biometric user data matches at least one of said plurality.

12. The method as recited in claim 1 wherein said handheld electronic device is a mobile communications device.

13. The method as recited in claim 12 wherein said mobile communications device is a mobile phone.

14. A device for controlling access to handheld electronic device functions, comprising:
a means for storing biometric reference data of an authorized user of said handheld electronic device functions;
a means for capturing biometric user data of a party requesting access to said handheld electronic device functions; and
a means for comparing said biometric user data with said biometric reference data.

15. The device as recited in claim 14 wherein said biometric reference data includes at least one first characteristic data set that unequivocally identifies said authorized user and said biometric user data includes a second characteristic data set that unequivocally identifies said party requesting access, and said comparing includes a comparison of said first characteristic data set and said second characteristic data

16. The device as recited in claim 14 wherein said biometric reference data is a facial image of said authorized user.

17. The device as recited in claim 14 wherein said means for capturing is a camera.

18. The device as recited in claim 16 further comprising capturing a facial image of said party requesting access and comparing it with said facial image of said authorized user using a position or arrangement, or both together, of salient points of said facial image of said authorized user and said facial image of said party requesting access.

19. The device as recited in claim 14 wherein said biometric reference data is selected from a group consisting of:
fingerprint data;
retina data;
iris data;
body geometry data;
voice data; and
DNA data.

20. The device as recited in claim 14 further comprising a means for storing a plurality of said biometric reference data and access to said handheld electronic device functions requires said party requesting access to designate at least two of said biometric reference data to be compared with said biometric user data.

21. The device as recited in claim 14 further comprising a means for matching a PIN entered by said party requesting access with a reference PIN.

22. The device as recited in claim 14 wherein said handheld electronic device is a mobile communications device.

23. The method as recited in claim 22 wherein said mobile communications device is a mobile phone.

24. A handheld electronic device controller, comprising;
a digital storage medium containing electronically readable control instructions to enable a handheld electronic device to control access to said handheld electronic device functions by comparing stored biometric reference data of an authorized user of said handheld electronic device functions with captured biometric user data of a party requesting access to said handheld electronic device functions; and
a means for activating said digital storage medium.

25. A handheld electronic device controller as recited in claim 24 wherein said digital storage medium is a microchip.
